(19) United States
(12) Patent Application Publication
(10) Pub. No.: US 2017/0043873 A1
(43) Pub. Date: Feb. 16, 2017

(54) POSITIONALLY RELEASABLE VEHICLE ARMOR ARRANGEMENT AND METHOD OF DEFEATING POSITIONAL LOCATION OF A PLATE FROM THE SAME

(71) Applicant: Sikorsky Aircraft Corporation, Stratford, CT (US)

(72) Inventors: Nancy Held-Sheehe, Bethany, CT (US); Gerald Sheehe, Bethany, CT (US)

(21) Appl. No.: 15/307,027

(22) PCT Filed: Apr. 24, 2015
(86) PCT No.: PCT/US15/27430

§ 371 Date: Oct. 27, 2016

Related U.S. Application Data
(60) Provisional application No. 61/985,806, filed on Apr. 29, 2014.

(51) Int. Cl. B64D 7/00; F41H 7/00

(52) U.S. Cl. CPC B64D 7/00; F41H 7/00

(57) ABSTRACT

A positionally releasable vehicle armor arrangement includes, at least one plate positioned proximate a hatch of a hatchway of a vehicle configured to shield an occupant of the vehicle from projectiles, at least one retainer in operable communication with the at least one plate configured to structurally maintain position of the at least one plate relative to the vehicle separately from the hatch, and a release in operable communication with the at least one retainer configured to defeat the structural positioning of the at least one plate maintained by the at least one retainer so that the at least one plate can be repositioned sufficiently to avoid obstructing egress through the hatchway.

### BACKGROUND

Ballistic panels or plates are often added to vehicles, such as rotary wing aircraft, for example, to protect the occupant from projectiles such as live fire directed through transparencies (e.g., windows) or other non-transparent, non-protective structure (such as airframe skins). When added beside cockpit seats, the plates are often also referred to as “wing armor.” Due to their protective role, these panels and their supportive systems must be sufficiently robust to block a significant number of projectiles (e.g., rounds) at speed.

Rotary wing aircraft cockpit configurations also often include egress hatchways adjacent to pilot and co-pilot seats to allow occupants a secondary means of egress in side-by-side configurations (those where a central companionway out of the cockpit and into the cabin exists). Under certain circumstances, that primary pathway out of the cockpit may be blocked. In other rotary wing aircraft cockpit configurations, the cockpit hatchway may be the only way into and out of the cockpit.

In conventional configurations, ballistic panel coverage area and effective egress area provided through a neighboring hatchway work against each other. A large ballistic panel or wing armor plate will provide greater protection to the occupants when experiencing live fire, but that protection will likely come at the expense of hindered egress from and movement within the cabin. Conversely, large transparencies (e.g., windows) or areas without robust structure facilitate movement but may offer little to no ballistic protection. Arrangements and methods that allow for these competing criteria to coexist are of interest to those who practice in the art.

### BRIEF DESCRIPTION

Disclosed herein is a positionally releasable vehicle armor arrangement. The arrangement includes, at least one plate positioned proximate a hatch of a hatchway of a vehicle configured to shield an occupant of the vehicle from projectiles, at least one retainer in operable communication with the at least one plate configured to structurally maintain position of the at least one plate relative to the vehicle separately from the hatch, and a release in operable communication with the at least one retainer configured to defeat the structural positioning of the at least one plate maintained by the at least one retainer so that the at least one plate can be repositioned sufficiently to avoid obstructing egress through the hatchway.

Further disclosed herein is a method of defeating positional location of at least one plate of armor proximate a hatch of a hatchway of a vehicle relative to the vehicle. The method includes, actuating a release, defeating positional retention of at least one plate relative to the vehicle separately from the hatch, and repositioning the at least one plate relative to the vehicle to avoid obstructing egress through the hatchway.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a portion of a vehicle showing where the positionally releasable vehicle armor arrangement disclosed herein is employed;

FIG. 2 depicts a perspective view of a positionally releasable vehicle armor arrangement disclosed herein;

FIG. 3 depicts an enlarged perspective view of a portion of the positionally releasable vehicle armor arrangement of FIG. 2;

FIG. 4 depicts another enlarged perspective view of a portion of the positionally releasable vehicle armor arrangement of FIG. 2;

FIG. 5 depicts another enlarged perspective view of another portion of the positionally releasable vehicle armor arrangement of FIG. 2;

FIG. 6 depicts a top view of an alternate embodiment of a positionally releasable vehicle armor arrangement disclosed herein;

FIG. 7 depicts an enlarged perspective view of a portion of the positionally releasable vehicle armor arrangement of FIG. 6;

FIG. 8 depicts a cross sectional view of a retainer of the embodiment of FIG. 7 in engaged with a receiver; and

FIG. 9 depicts a similar cross sectional view to that of FIG. 8 with the retainer partially disengaged from the receiver.

### DETAILED DESCRIPTION

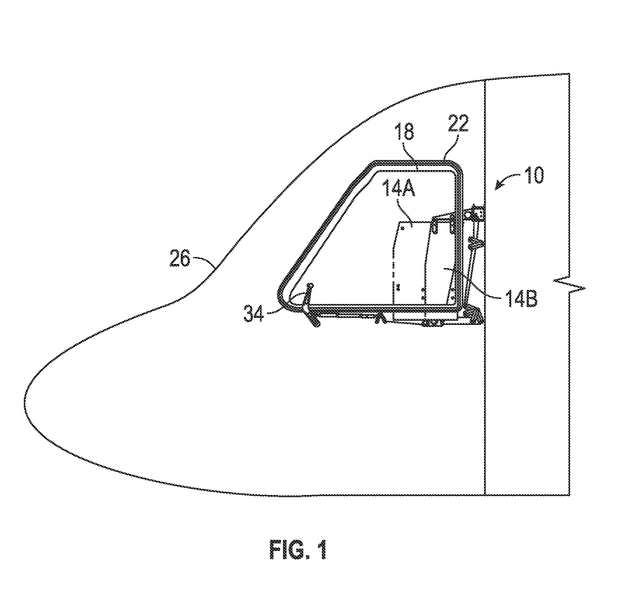

Referring to FIGS. 1-5, an embodiment of a positionally releasable vehicle armor arrangement disclosed herein is illustrated generally at 10. The arrangement 10 includes, at least one plate, with two plates 14A, 14B being shown in one embodiment, positioned proximate a hatch 18 of a hatchway 22 of a vehicle 26, the vehicle being illustrated herein as an aircraft. The plates 14A, 14B are configured to shield an occupant (not shown) of the vehicle 26 from projectiles (not shown). At least one fastener or retainer, with three retainers 30A, 30B, 30C being shown as pins in one embodiment, being in operable communication with the plates 14A, 14B to structurally maintain position of the plates 14A, and 14B relative to the vehicle 26 separately from the hatch 18. A release 34, shown as a lever in one embodiment, is in operable communication with the retainers 30A, 30B, and 30C and is configured to defeat the structural positioning of the plates 14A, 14B provided by the retainers 30A, 30B so that the plates 14A, 14B can be repositioned sufficiently to avoid obstructing egress through the hatchway 22. The positioning of the plates 14A, and 14B relative to the vehicle 26 can be maintained and defeated independently of the position of the hatch 18 relative to the vehicle 26.

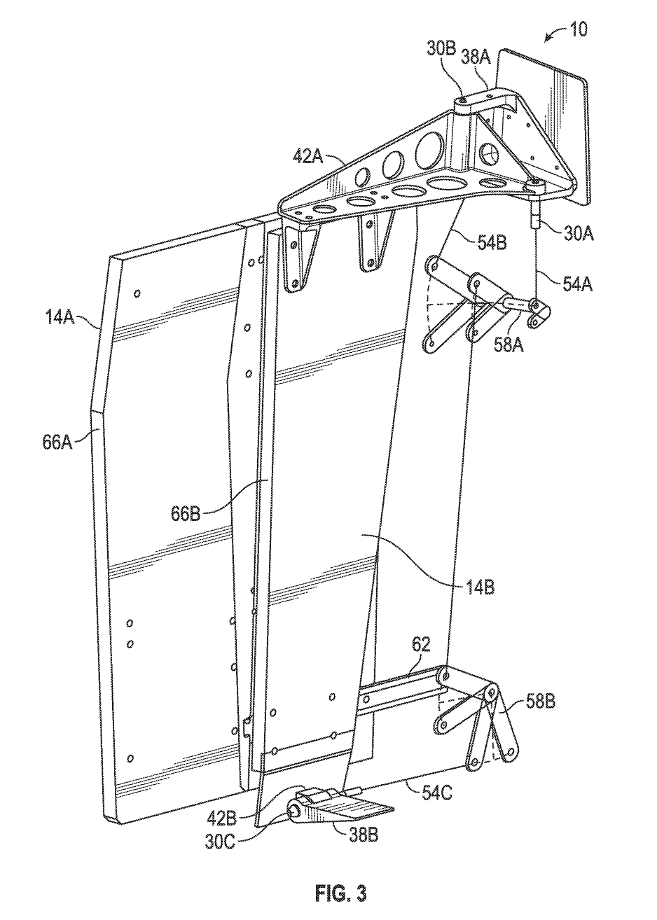

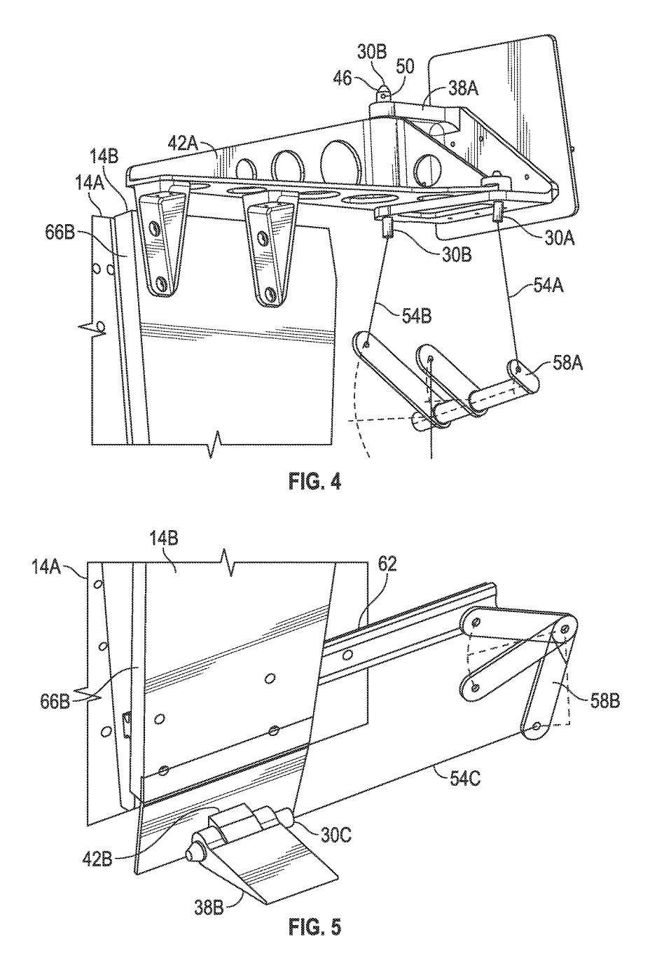

The two retainers 30A, 30B, as best seen in FIGS. 3 and 4, extend through a support 38A of the vehicle 26 and into a receiver 42A, illustrated herein as a bracket attached to the plate 14B. The retainers 30A and 30B have detents 46, such as a spring loaded ball 50, to prevent the retainers 30A, 30B from inadvertently coming dislodged from the receiver 42A and the support 38A. Similarly, the retainer 30C extends through a support 38B of the vehicle 26 and into a receiver 42B that is attached to the plate 14B. Other suitable means of preventing the retainers 30A, 30B and 30C from inadvertently becoming dislodged from their respective receivers and supports may include over-centering, safety wire, frictional devices, keyways and tabs.

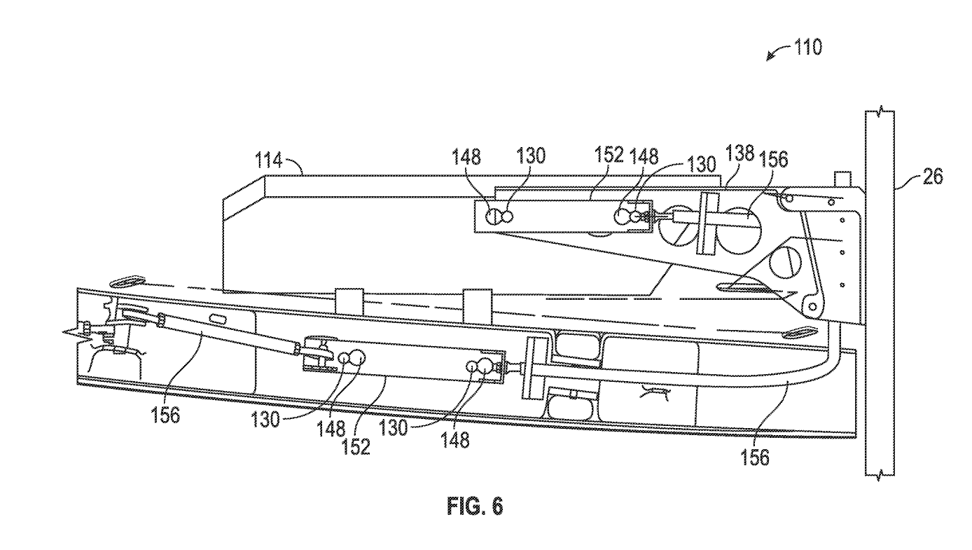

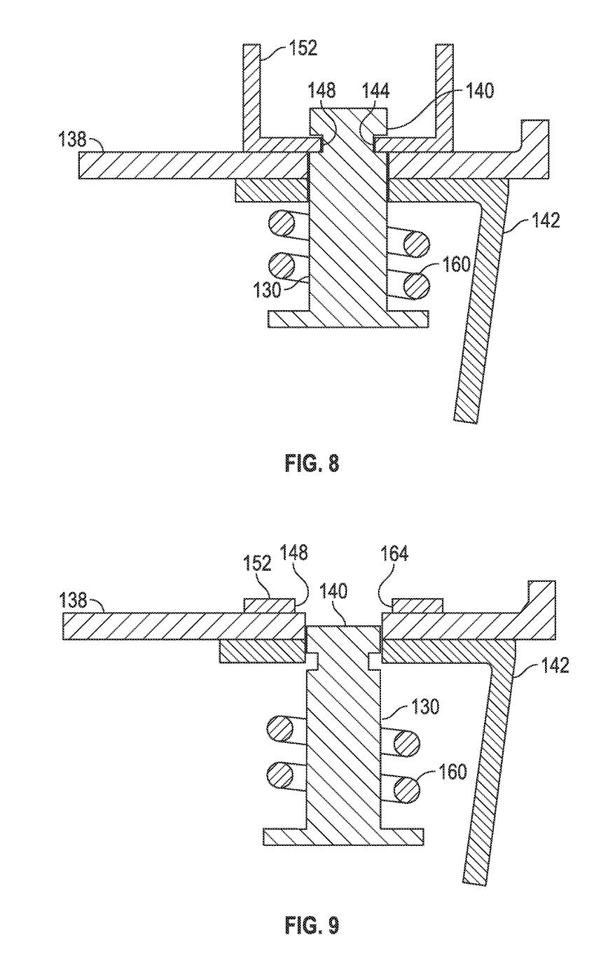

The retainers 30A, 30B, and 30C are removed from at least the receivers 42A and 42B (and may additionally be removed from the supports 38A and 38B as well) by links 54A, 54B and 54C, respectively. The removal of the retainers 30A, 30B, and 30C from the receivers 42A and 42B fully disconnects the plates 14A, 14B from the vehicle 26 thereby allowing the plates 14A, 14B to be moved to a position that no longer obstructs the hatchway 22 including discarding the plates 14A, 14B from the vehicle 26 entirely. The links 54A, 54B and 54C, shown in this embodiment as rods, are moved in response to movement of articulating members 58A and 58B that are articulated by actuation of the release 34. The articulating members 58A and 58B may be movable between two over-center positions that provide stability in either of the two positions, thereby providing retention of the retainers 30A, 30B and 30C via compression forces in the rods 54A, 54B and 54C when the articulating members 58A and 58B are in the initial positions. It should be appreciated that other embodiments may be employed to defeat positional fixing of the plates 14A, 14B to the vehicle 26 such as that illustrated in reference to FIGS. 6-9 below.

Although only a single one of the plates 14A, 14B is needed, the illustrated embodiment includes the two plates 14A and 14B. The plate 14A is slidably movably mounted to the plate 14B via slide 62. This movability of the plate 14A allows for improved egress through the hatchway 22 (beyond that provided solely by removal of hatch 18) without defeating the structural positioning of the plate 14B relative to the vehicle 26. This is accomplished by sliding the plate 14A such that an edge 66A of the plate 14A is substantially aligned with an edge 66B of the plate 14B. Since the plates 14A, 14B still partially occlude the hatchway 22 even when the plate 14A has been moved, the additional repositioning of the plates 14A, 14B that is allowed with the releasing of the retainers 30A, 30B, and 30C to thereby remove all occlusion of the hatchway 22 by the plates 14A, 14B via embodiments disclosed can be beneficial. This full removal of obstruction can be accomplished even if the slide 62 were to malfunction due to damage or debris, for example, and can make egress easier for persons who are injured or are carrying extra gear when attempting to egress including during emergency situations, for example.

The release 34 can be operatively connected to the hatch 18 through mechanisms other than those that are in operable communication with the retainers 30A, 30B, 30C such that actuation of the release 34 also allows the hatch 18 to open the hatchway 22 or to become fully disconnected from the vehicle 26 in a manner similar to the disconnection of the plates 14A, 14B upon release of the retainers 30A, 30B, and 30C.

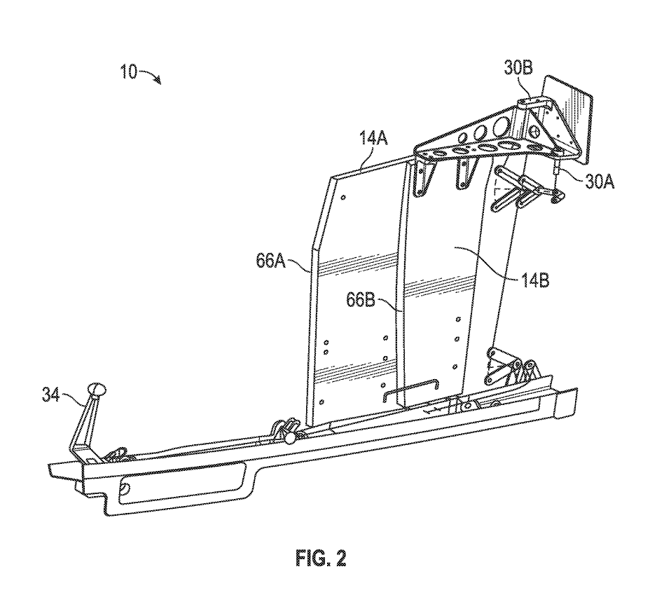

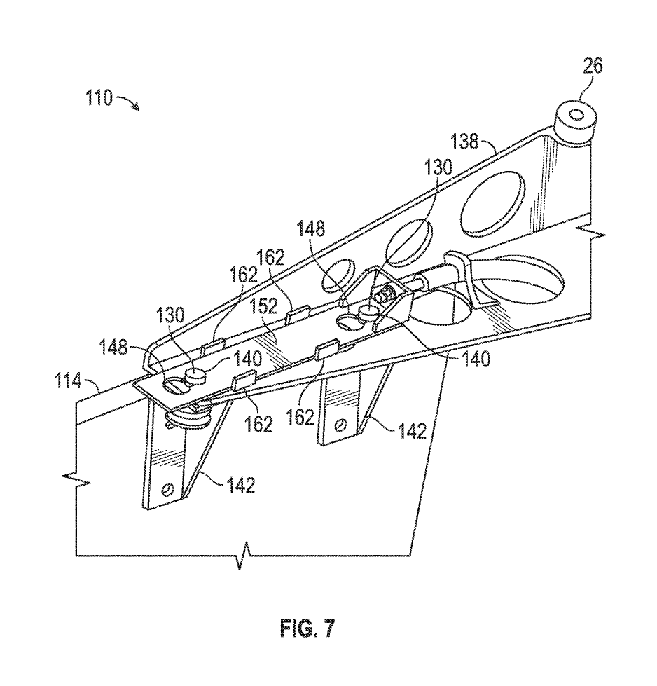

Referring to FIGS. 6-9, an alternate embodiment of a positionally releasable vehicle armor arrangement disclosed herein is illustrated at 110. There are similarities between the arrangements 10 and 110 and as such like elements are identified with the same reference characters. The arrangement 110 includes one plate 114. There are four fasteners or retainers 130, illustrated in the embodiment shown as pins, two of the retainers 130 are engaged between a support 138 attached to the vehicle 26, or a portion of the vehicle 26, and a receiver 142 attached to the plate 114 and two of the retainers 130 are engaged between another of the supports 138 attached to the vehicle 26 and another of the receivers 142 attached to the plate 114. Each of the retainers 130 has a head 140 engaged with a small portion 144 of a keyhole 148 in a slide 152. The slide 152 is movable relative to the support 138 by a link 156 movably actuatably connected to the release 34 (FIGS. 1 and 2). The retainers 130 are biased relative to the slides 152 by a biasing member 160, shown herein as a spring. Guides 162 (shown in FIG. 7 only) on the support 138 assure alignment of the retainers 130 with the slides 152 during movement of the slides 152. The foregoing structure assures that once the slides 152 have moved sufficiently for the head 140 to be fully within a large portion 164 of the keyhole 148 the retainer 130 is removed from both the slide 152 and the receiver 142 thereby disconnecting the plate 114 from the vehicle 26. Once disconnected the plate 114 can be repositioned so it does not obstruct exiting the vehicle 26 through the hatchway 22.

Although the embodiments illustrated herein include retainers that are withdrawn from receivers without fracturing of either the retainers or the receivers, alternate embodiments are contemplated wherein components such as the receivers or the retainers are frangible and are therefore broken or sheared to allow plates to become repositionable.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A positionally releasable vehicle armor arrangement, comprising:
at least one plate positioned proximate a hatch of a hatchway of a vehicle configured to shield an occupant of the vehicle from projectiles;
at least one retainer in operable communication with the at least one plate configured to structurally maintain position of the at least one plate relative to the vehicle separately from the hatch; and
a release in operable communication with the at least one retainer configured to defeat the structural positioning of the at least one plate maintained by the at least one retainer so that the at least one plate can be repositioned sufficiently to avoid obstructing egress through the hatchway.

2. The positionally releasable vehicle armor arrangement of claim 1, wherein the at least one plate at least partially obstructs egress through the hatch prior to defeat of the at least one retainer.

3. The positionally releasable vehicle armor arrangement of claim 1, wherein the at least one retainer is defeated by removing the at least one retainer from a receiver.

4. The positionally releasable vehicle armor arrangement of claim 3, wherein at least one of the at least one retainer is maintained in the receiver by at least one link.

5. The positionally releasable vehicle armor arrangement of claim 1, wherein the at least one retainer is a pin.

6. The positionally releasable vehicle armor arrangement of claim 1, wherein at least a portion of the at least one plate is movable relative to the vehicle prior to defeat of the structural positioning of the at least one plate maintained by the at least one retainer.

7. The positionally releasable vehicle armor arrangement of claim 6, wherein the movability is via sliding of the at least a portion of the at least one plate.

8. The positionally releasable vehicle armor arrangement of claim 1, wherein the at least one retainer is frangible.

9. The positionally releasable vehicle armor arrangement of claim 1, wherein the release is also in operable communication with the hatch such that actuation of the release allows the hatch that covers the hatchway to be opened through a mechanism other than the at least one retainer.

10. The positionally releasable vehicle armor arrangement of claim 1, wherein the vehicle is an aircraft.

11. The positionally releasable vehicle armor arrangement of claim 1, wherein the at least one plate is completely detached from the vehicle when the structural positioning of the at least one plate maintained by the at least one retainer is defeated.

12. A method of defeating positional location of at least one plate of armor relative to a vehicle, comprising:
actuating a release;
defeating positional retention of the at least one plate of armor relative to the vehicle independently from a hatch of a hatchway of the vehicle; and
repositioning the at least one plate relative to the vehicle to avoid obstructing egress through the hatchway.

13. The method of defeating positional location of at least one plate of armor relative to a vehicle of claim 12, further comprising fully detaching the at least one plate from the vehicle.

14. The method of defeating positional location of at least one plate of armor relative to a vehicle of claim 12, further comprising withdrawing a retainer from a receiver.

15. The method of defeating positional location of at least one plate of armor relative to a vehicle of claim 12, further comprising breaking a retainer.
